(19) United States
(12) Patent Application Publication
(10) Pub. No.: US 2002/0032870 A1
(43) Pub. Date: Mar. 14, 2002

(54) Web browser for limiting access to content on the internet

(76) Inventors: Martin Spusta, Clinton Township, MI (US); James Cummings, Chesterfield Township, MI (US); Gerald L. Howe, Clinton Township, MI (US)

Correspondence Address: ARTZ & ARTZ, P.C., 28333 TELEGRAPH RD., SUITE 250, SOUTHFIELD, MI, 48034, US

(21) Appl. No.: 09/851,770

(22) Filed: May 9, 2001

Related U.S. Application Data
(60) Provisional application No. 60/232,330, filed on Sep. 13, 2000.

(51) Int. Cl. G06F 15/173

(52) U.S. Cl. 713/201

(57) ABSTRACT

A web browser system has a network that connects a user computer having a local database with local database entries therein with a central database having central database entries therein. A web browser has a domain name entry area for entering a domain name corresponding to the website. A controller compares the domain name to a plurality of database entries within a local database. When the domain name is not in the local database, the domain name is compared to a plurality of central database entries in a central database through the network. When the domain name is in the local database or central database, access to the website is enabled. In addition to the system, parsing is performed to determine the final destination and domain name. The website may also include sponsorship information in an educational format.

### RELATED APPLICATION

The present invention claims priority to provisional application No. 60/232,330 filed on Sep. 13, 2001.

### TECHNICAL FIELD

The present invention relates generally to an apparatus and method for limiting access to content on a network, and more particularly, to an apparatus and method for limiting or allowing access to content on the Internet deemed unsuitable or suitable by an administrator.

### BACKGROUND OF THE INVENTION

As the proliferation of the Internet increases, the variety of types of content also increases. Children in their studies now require access to the Internet to perform various tasks. Some content on the Internet, however, may not be suitable for children of various ages.

To restrict access to websites, various systems are known. One system for restricting access uses a key that is provided to a user upon age verification. The drawback to such a system is that not all websites that include unsuitable content require a key for access. Therefore, access to these systems may be undesirably allowed.

Web browsing systems are also known that store a list of disapproved websites on the user's computer. If the website sought to be accessed is on the disapproved list, access is denied. One drawback to such a system is that Internet content providers continually change the access addresses and new sites are constantly being added. Therefore, such lists become outdated nearly as fast as they are created. Another drawback to such a system is that the lists are typically restricted to adult oriented websites. Unfortunately, well-known websites may have content that is not age appropriate. Such systems do not distinguish the age appropriateness of such content and therefore either denies access to all content or allows access to such content even though the content is not appropriate for the user.

Another practice on the Internet includes redirecting users who enter a first website address and are automatically rerouted to another website with another address. Known systems cannot prevent the redirection of the user and therefore a redirected user may end up at a site with inappropriate content.

It would therefore be desirable to provide a web browsing system that allows age appropriate access to approved sites while preventing access of users to inappropriate websites.

### SUMMARY OF THE INVENTION

The present invention provides an improved browser system that includes a network that connects a user computer having a local database with local database entries therein with a central database having central database entries therein. A web browser has a domain name entry area for entering a domain name corresponding to the website. A controller compares the domain name to a plurality of database entries within a local database. When the domain name is not in the local database, the domain name is compared to a plurality of central database entries in a central database through the network. When the domain name is in the local database or central database, access to the website is enabled.

In a further aspect of the invention a method for accessing a web page comprises:

entering a domain name corresponding to a website;

comparing the domain name to a plurality of local database entries, local database having a plurality of local database entries;

when the domain name is not in the local database, comparing the domain name to a plurality of central database entries in a central database;

when the domain name is in the local database or central database, enabling access to the website.

In a further aspect of the invention, a method of sponsoring a website comprising:

generating a screen display having a plurality of subject buttons;

selecting and actuating a first subject button from said plurality of subject buttons;

displaying a question and a plurality of answers in response to the step of selecting;

displaying a first sponsor code on said display;

selecting a first answer from the plurality of answers;

displaying a narrative display in response to the step of selecting a first answer.

In yet another aspect of the invention, a method for parsing a domain name entry comprises:

entering a full domain name having a plurality of character positions;

capturing the full domain name;

capturing a first domain name by capturing characters right of a first symbol and left of a second symbol to obtain a first name.

Yet another aspect of the invention includes updating advertising information on a website and browser;

providing a local computer ad code having a first plurality of bits and a central computer ad code and a second plurality of bits;

comparing the local computer ad code with the central computer ad code;

when the local computer ad code is not equal to the central computer ad code, downloading an ad to the local computer from the central computer.

One advantage of the invention is that the system is easily adaptable allowing children to access to various websites suitable for their age group. Also, the present invention is adaptable to business uses so that various business levels may be established rather than age appropriate level for children's applications.

Yet another advantage of the invention is that unintended redirection to inappropriate content sites is prevented using the parsing process.

The method for sponsoring or advertising on the website encourages children to learn by allowing points to be collected and redeemed for prizes.

Another advantage of the invention is that various plug-ins and other media installed on web browsers such as Microsoft's Internet Explorer® will be accessible through the browser of the present invention.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagrammatic view of a system according to the present invention.

FIG. 2 is a screen layout of one embodiment of a display for the present invention.

FIG. 3 is a block diagrammatic view of the operation of a first portion of a web browser system according to the present invention.

FIG. 4 is a flow chart of a method of operating the parsing domain name after the website address has been entered as a desired network destination.

FIG. 5 is a flow chart of the method of access approval according to the present invention.

FIG. 6 is a flow chart of the method of operating an e-mail system according to the present invention.

FIG. 7 is a block diagram illustrating a screen display for an educational aspect of the invention.

FIG. 8 is a system level view with another screen display for an educational aspect of the present invention.

FIG. 9 is another screen display representative of the present invention.

FIG. 10 is a flow chart of a method for operating the education aspect of the invention.

FIG. 11 is a first table of the central database of the present invention.

FIG. 12 is a second table of the central database of the present invention.

FIG. 13 is a flow chart of a method for rescreening websites according to the present invention.

FIG. 14 is a flow chart of a method for a gathering process of the present invention.

### DETAILED DESCRIPTION OF THE PREFERRED EMBODIMENT

In the following figures the same reference numerals will be used to identify the same components in the various views. Specific examples of displays, systems and methods are given below for preferred features of the browser according to the present invention. However, those skilled in the art will recognize that various other features may be included without varying the scope of the invention. The terms domain name, website address, and URL are used interchangeably and refer to an intended destination on a network such as the Internet.

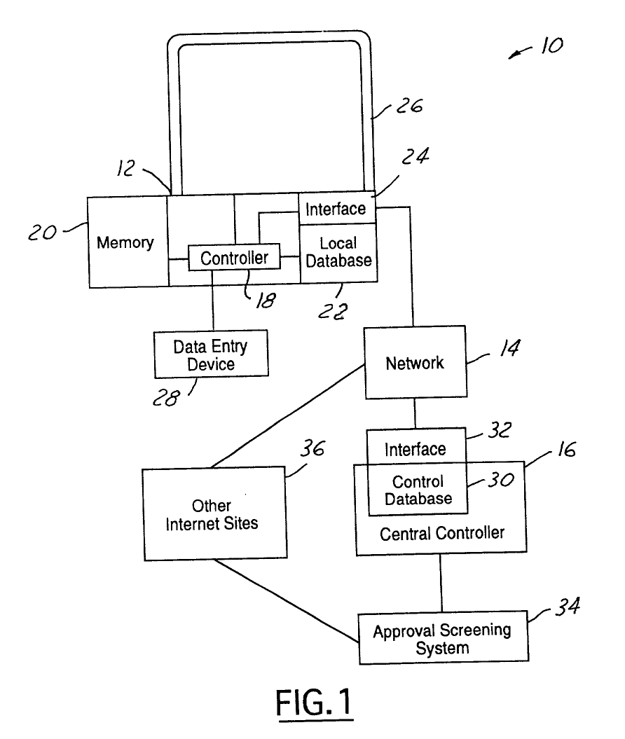

Referring now to FIG. 1, a browser system 10 according to the present invention is illustrated. Browser system 10 has a local computer 12 that is coupled to a network 14. Network 14 is coupled to a remote or central controller 16. Network 14 may, for example, be one of a number of various types of connections to the Internet such as phone lines, DSL lines, ISDN lines, T1 lines, satellite connections or cable modems. Although only one local computer 12 is illustrated, various numbers of local computers 12 are contemplated by the present invention. The number of local computers 12 may vary depending on a subscription or other type of access to central controller 16. “Central” or “remote” when describing controller or database refers to the device or database being located away from or separated from the local computer by the network 14.

Local computer 12 has a local controller 18 that is microprocessor based. Controller 18 controls the operation of local computer 12 and the operation of a memory 20, a local database 22, a network interface 24, and a display 26. Although memory 20 and local database 22 are illustrated as separate components, these components may be combined into a single memory 20. Memory 20 stores the software to run the web browser in response to data entry device 28.

Data entry device 28 may be one of a various number of data entry devices such as a keyboard, a mouse, a touch screen or other devices used in computer applications. The operation of the browser will be further described below.

Local database 22 may include various entries and be formatted into tables as will be further described below. The local database entries may include approved website data, age appropriateness and various other data. The local database may also include user approved websites or authorization to access websites not approved by the central controller as will be further described below.

Central controller 16 may be one or a plurality of computers or servers used to store a central database 30 which may be coupled to network 14 through an interface 32. Central database 30 has central database entries that will be used in the operation of the browser system as will be described below. The entries may also be arranged in tables as will be described below.

Central controller 16 may be coupled to an approval screening system 34 that may be used to approve websites for insertion into central database 30. Approval screening system 34 may be coupled to other Internet sites 36 and screens the other Internet sites 34 for appropriate content. Approval screening system 34 provides the desired data regarding age appropriateness and the like to central database 30. The approval screening system will be further described below.

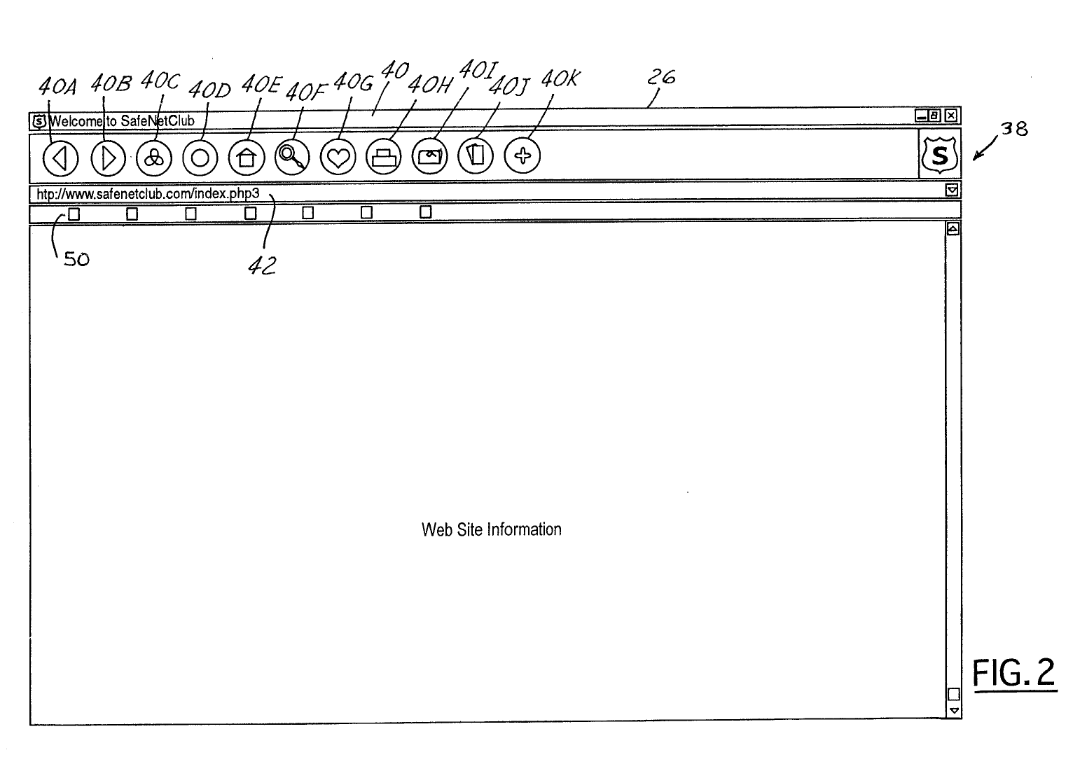

Referring now to FIG. 2, display 26 is illustrated in further detail. Display 26 displays a browser 38, which is a graphical user interface. Browser 38 includes many navigation controls 40 which may include, for example, back button 40A, forward button 40B, stop button 40C, refresh button 40D, home button 40E, search button 40F, favorites button 40G, print button 40H, e-mail button 40I, games button 40J, and help button 40K. These buttons control the operation and navigation through the Internet as is common in the operation of commercially available Internet browsers.

A website URL address display 42 is used to display the current website as well as enter a requested website to be navigated to. Various characters 44 may also be included on display 26 within browser 38.

An advertising or sponsorship 50 may also be positioned on the browser 38. The sponsorship area 50 may be positioned in various or multiple areas on browser 38. As illustrated, sponsorship area is positioned on the leftmost side of the display. However, various or multiple areas on the display may be used.

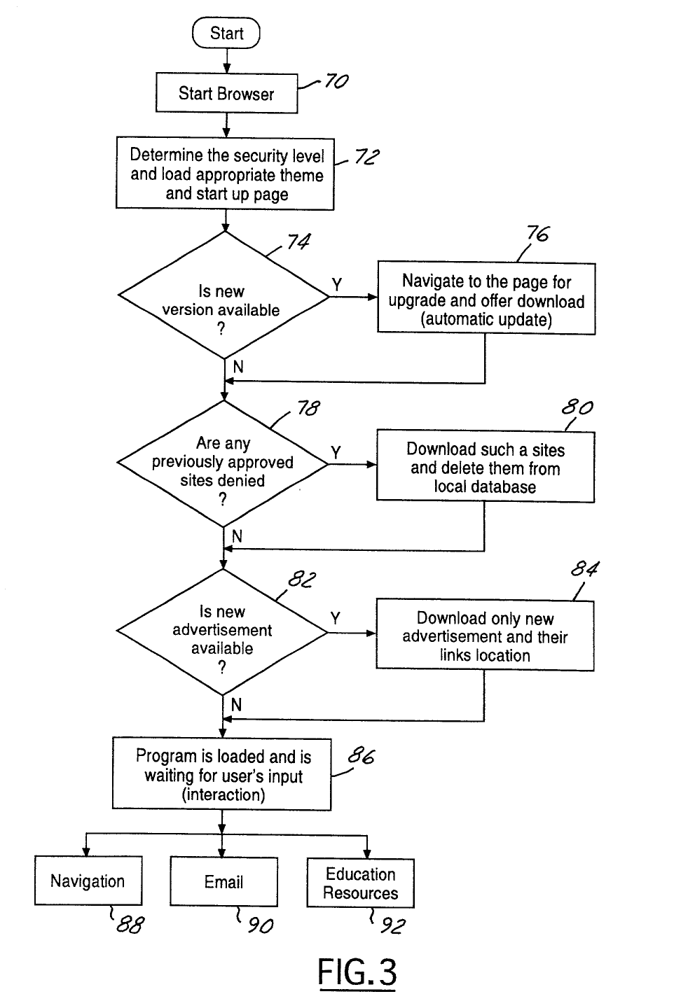

Referring now to FIG. 3, the browsing process is started at start browser step 70. Preferably, the browser is started by double-clicking on the browser icon located on the desktop display of the local computer or automatically as a default gateway to the rest of the computer. The browser may then have a sign in or selection for the user's name which then determines the security level and load an appropriate theme in start up page for that user in step 72. In step 72, various start up pages may also be associated with various age levels. For example, grades 2 and under may have a first page, grades 3 through 7 a second page, and grades 8 through 12 a third page. For a business application, various levels of employees may also have access to various content on the Internet. For example, system administrators may have complete access to the Internet while mailroom clerks may have access to the company's website through an Intranet.

After step 72, step 74 determines whether a new version of the browser software is available. This step may be performed by accessing central computer through the network. A website may be checked and the current version of the program determined. In step 76, if a new version is available an “upgrade now” button may appear and a free or charged-for upgrade may be provided to the user. The version is updated in step 76.

In step 74, if a new version is not available and in step 76 if an upgrade is performed, step 78 is executed. Step 78 determines if any previously approved sites in the local database have been recently denied access. This step is important if the content of a website has changed. The screening process will be further described below. If previously approved sites have a changed status to “not approved”, step 80 is executed in which the sites that have been denied are deleted from the local database. If any previously approved sites have not been denied or in step 80 if the downloading and deletion from the local database is complete, step 82 is executed. In step 82, advertising or sponsorship information may be provided to the screen display. In step 82, if new advertising is available, then step 84 is executed in which new advertising is loaded with their respective links onto the browser from the central computer. This process is further described below.

After step 84 and if in step 82 no new advertising is available, the browser program is loaded and displayed in step 86. After step 86 user interaction is required to enter three main portions of the program; either navigation 88, e-mail 90 or education resources 92. These three portions will be further described below. Of course, other tools and sections may be provided such as searching, games, news, equipment purchasing, links and entertainment.

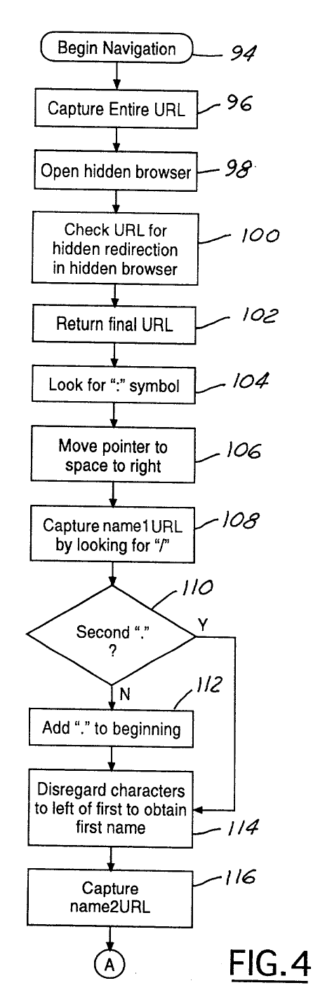

Referring now to FIG. 4, the navigation process is initiated by some user interaction in step 94. The navigation process is initiated by a user typing in (for example in URL display 42 of FIG. 2) or selecting a desired URL (Uniform Resource Locater). Before navigation can begin, a parsing process is performed to determine whether or not permission has been granted for the site for the particular security level. In step 96, the entire entered URL is captured and a hidden browser is opened in step 98 so that redirection technique may be uncovered. The hidden browser is hidden from view and therefore not accessible to an end user. The URL is then checked for hidden redirection in hidden browser in step 100. If in step 100 a redirection has been performed or not performed, a final URL is returned in step 102. It should be noted that the parsing process does not wait for the complete page to be downloaded. The parsing process requires the final destination of the HTML document. After the HTML text is loaded the parsing process stops the navigation of the hidden web browser object and thus stops the loop.

A final returned URL is returned in step 102. The final returned URL in step 102 may, for example, be http://maps.yoohoo.com/index.html. If this is the case, one or more names may be returned by the parsing process. The pointer of the parsing program starts at the left and looks for the first colon in step 104. After the colon, the pointer moves two places to the right in step 106. Two places were chosen to avoid the two slashes. The desired name is then captured. Everything between the second place and the first slash is used as name1 in step 108.

After step 108, step 110 is executed in which the presence of a second period in the name is determined. If a second period is not present, step 112 is executed in which a period is added to the beginning of the name. If a second period is present in step 110, step 114 is executed. Step 114 is also executed after step 112. In step 114, the characters to the left of the first period are disregarded. In the present example, “.yoohoo.com” is captured as name2. By allowing two names to be captured from a single URL, a portion of the website may be accessible such as the map portion in the present example while the entire website may not be accessible because some content may not be suitable for all users. Advantageously, this method for parsing can apply to foreign languages as well.

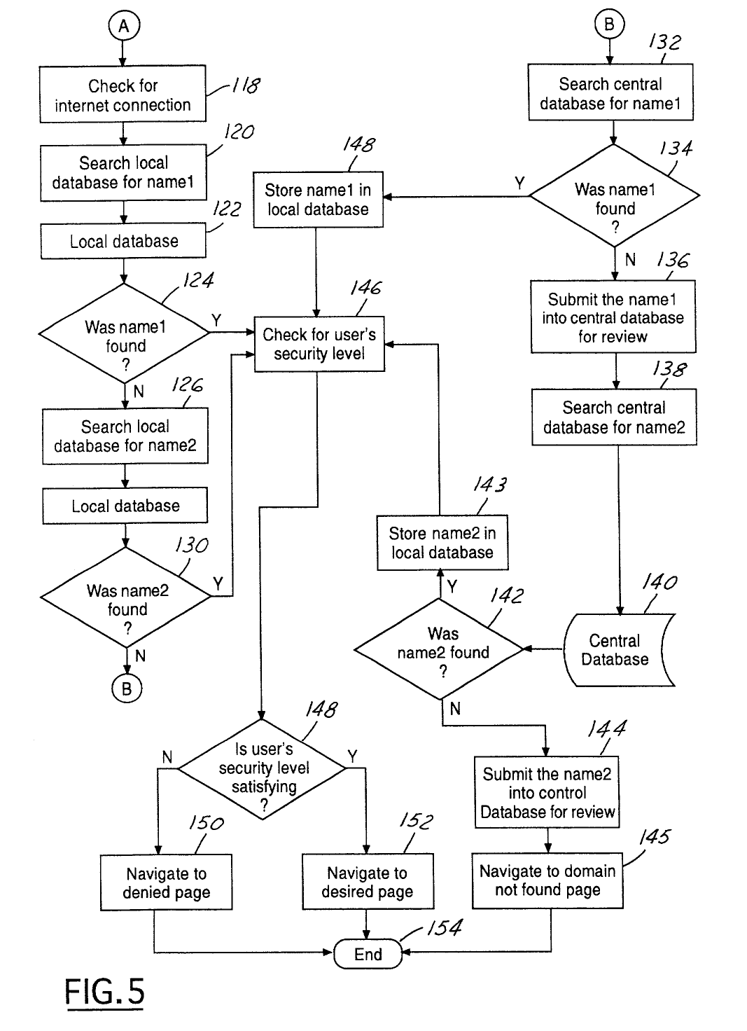

Referring now to FIG. 5, an approval portion of the process started in FIG. 4 is performed. In this process, an Internet connection is checked for in step 118. Internet connection in step 118 may be one of several types of connections including a cable, DSL or dial-up modem. This step may have been previously performed in FIG. 4 prior to or as part of the step of checking for a new version. If so, this step may be eliminated. In step 120, the local database on the local computer is searched for name1. If name1 was not found in the local database in step 124, step 126 is executed in which name2 is searched for in the local database in step 128. It should be noted that “found”, “not found”, and “within” when referring to the database refer to whether or not the site is approved. Thus, when a website name is “found”, it is envisioned that it is on the “approved” (accessible) list of sites. The database may actually contain information on disapproved sites as well.

If name2 is not found (not approved) in the local database in step 130, step 132 is executed. In step 132 the central or remote database is searched for name1. After step 132, step 134 is executed in which if name1 was not found, step 136 is executed. In step 136, name1 is submitted to the approval screening system 34 of FIG. 1.

After step 136, step 138 is executed in which the name2 is compared to the central database of step 140. Step 142 is executed in which if name2 was not found, step 144 is executed in which name2 is submitted to the approval screening system 34 of FIG. 1. The above path represents a scenario in which name1 or name2 was not found in either the local database or the central database. Therefore, step 144 issues a domain not found page 145 and prevents the further navigation to the desired site. The system process has an end step 154 in which the process is ended.

Referring back to step 142, if name2 was found in the central database (and name1 was not found in the local database) then name2 is stored in the local database in step 143, then step 146 is executed. This may be performed by adding a new table entry containing the desired data into the local database. The entry may be all or part of the tables described below which is transferred through the network.

Referring back to step 134, if name1 was found in the central database (not found in the local database) step 148 is executed. In step 148 name1 is stored in the local database in the same manner described above.

Referring back to steps 124, 130, if respective name1 was found in step 124 or name2 was found in the local database in step 130, step 146 is executed. Step 146 is also executed if name1 was found in the central database in step 134 or name2 was found in the central database in step 142. In step 146, the user's security level is checked. This may correspond to the grade levels of children described above. After step 146, step 148 is executed in which the user's security level is determined whether or not it satisfies the particular level of the website. Thus, a comparison is made between a database entry indicating level and the level of the current user. If the site has a security level beyond that of the website, then step 150 is executed in which access to or navigation to the website is denied. In step 148 if the user's security level is greater than or corresponds with the security level of the website, then the navigation is allowed to the website.

It is envisioned that the process of FIG. 5 may be implemented by returning an XY value back to the browser software where X is a first value corresponding to 0=not found, approved=1, pending=2, or denied=3, and the values for Y correspond to security levels. For example, security levels 1-12 may be used. When X=0 this indicates the page was not found in the database and will be submitted for review as described further below. The next time someone accesses the database the domain name will be found and the response of “the requested site is currently being reviewed, try again later” will be issued.

When X=1 this indicates that the domain name was found and is approved. Therefore, the user's security will be checked as in step 148. If the user's security level is less than the approved domain's security level, a message will be displayed saying the domain name is not appropriate for the user's security level. Even if the security level does not match the security level, the local database will be updated with the security level and domain name in case other users with higher security levels are users to the system. This will prevent the need for querying the central database for this item.

When X=2, this indicates that the page was found in the central database but is being currently reviewed as mentioned above by the approval screening system or approval entity such as actual staff members of the company. A display such as “the requested site is currently being reviewed, try again later” may be entered but the domain name is not provided into the local database.

When X=3 this indicates that a page was found but it has been denied for a specific reason. This allows the company to control various content which may become accessible in the future. The denied domain names are not stored in the local database because the next time the domain is requested it will again be compared against the Internet database in the case that it does become approvable. The process ends in step 154 in which the program returns back to the beginning of FIG. 4 if another navigation is attempted.

In addition to the above safeguards, a computer lock for local websites or content contained on the user's computer may be provided. In this case, the parents or administrators may control the use of the program's files, browsers and system settings in a similar manner to that described above. Certain users may be given rights to access certain programs or other browser wherein other users may not. This may prevent younger users from unintentionally destroying parents' financial or other information stored on the computer.

By preventing access to other browsers, the current system cannot be bypassed.

Various other features may be employed in browser 26 such as the options to change the theme such as background color, pictures, custom-made navigation buttons, various logos, sounds and other options to encourage a safe, fun and unique browsing experience.

Also, the parents or administrators may be able to choose a setting to override the central or local database for a particular website. By choosing a specific website and storing on the local computer, the local computer may then deny the site to be accessed.

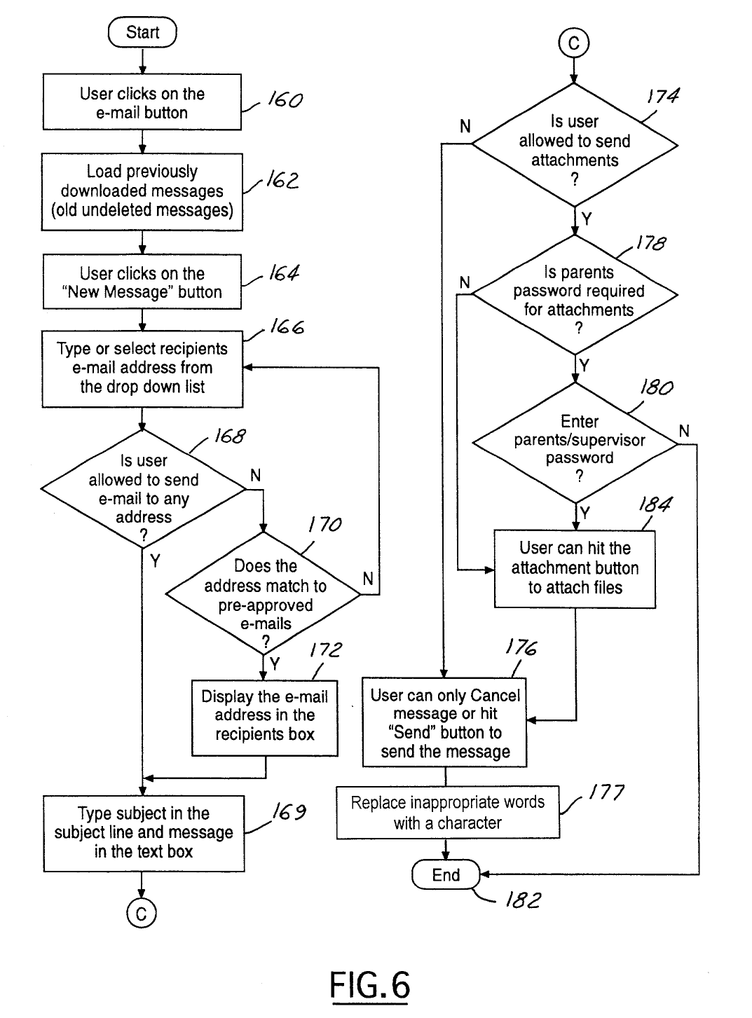

Referring now to FIG. 6, when a user from FIG. 3 clicks on e-mail button 90, the process of FIG. 6 is initiated. It should be noted this process is described for sending an e-mail. Those skilled in the art will also recognize this process may also be reversed for receiving an e-mail. At step 160, previously downloaded messages, i.e., old undeleted messages, are checked in step 162. A user clicks on the new message button in step 164. In step 166, to form a new e-mail the address of the recipient is typed in or selected from a drop down list. A drop down list may be obtained from a look-up button on the browser. A look-up button is suitable for small children who cannot remember the e-mail addresses of their friends. The use of this feature will ensure that the e-mail addresses are correctly inserted each time an e-mail is sent. Further, access for sending e-mails may also be restricted. In step 168 the e-mail system may determine whether a user is allowed to send e-mails to any address. If the user is allowed, the subject line and the message may be typed in in step 169. If in step 168 the user is not allowed to send addresses to all other users, step 170 is executed. In step 170 if the address does not match preapproved e-mail addresses, step 166 is again executed so that another recipient e-mail address may be again typed in. In step 170 if the address does match the preapproved e-mail list, then step 169 is executed. Step 169 is also executed after step 168. After step 169 the subject and message prompts are provided to the user so that they may be filled in prior to sending the e-mail.

In step 174 it is determined whether the user is allowed to send attachments. If the user is not allowed to send attachments, a message is provided in step 176 which prevents attachments from being sent and may prompt the user with a send button for sending the e-mail without attachments. Step 177 is then executed in which any inappropriate words are replaced with a generic character such as an asterisk.

Referring back to step 174, if the user is allowed to send attachments step 178 is executed. Parents may also provide a password to allow children to provide attachments within their e-mails. In step 178 a prompt is provided for the parents' password. In step 180 the parents' password is entered. If the parents' password entered is not a proper password the system is ended in step 182. If the parents' password is a proper password then step 184 is executed in which the user is then prompted for an attachment. In step 178, if a password is not required then the parental password is not prompted in step 180 and step 184 is then executed. After step 184, the user is prompted with a send button so that after step 184 an e-mail with attachments may be sent.

Other functions of the e-mail system may include a read button which allows the program to read verbally the e-mail received. This is an especially useful feature for children. Security settings may also be included into the system so that e-mail may not be sent or received from certain e-mail addresses. Also, various words may be filtered or e-mails with various words may be filtered out and not delivered to the children's inbox. Also, attachments may also be required to have a password such as in the configuration in step 178 above but on the receive side. Attachments may be automatically deleted from e-mails or be stored in a parental database where they may be forwarded to a child or somebody without previous authority upon review.

In step 169, the e-mail program may detect to determine whether or not a valid e-mail address has been entered. For example, the “@” symbol and an e-mail address having no spaces may be checked to help validate the e-mail entry. When an e-mail message has been received, incoming and outgoing messages may be scanned for inappropriate words and those words may be deleted or replaced with an asterisk. If e-mail monitoring has been chosen, the incoming or outgoing e-mail messages may be saved for parental review. However, the save messages may not be filtered so that a parent may view a message.

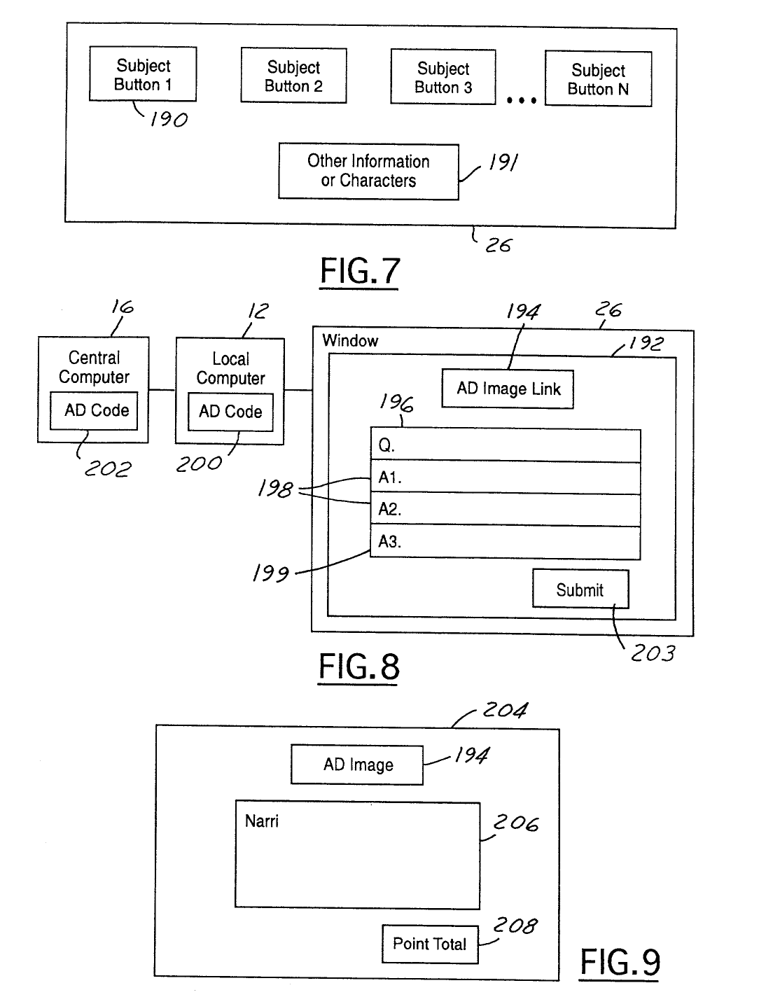

Referring now to FIG. 7, advertising or sponsorship may also be performed in the web browser. This advertising or sponsorship is generally indicated FIG. 3 as education resources 92. Upon clicking an education resource button such as those illustrated as 50 in FIG. 2, an advertising process may be initiated. In this embodiment, display 26 may have various subject buttons 190 that appear on display 26. Subject buttons 190 may invoke educational items such as questions and answers along with specific sponsorship information or other information 191 such as advertising and/or advertising links to a sponsor's website.

Referring now to FIG. 8, once a subject button is launched, display 26 may display a window 192 that includes an ad image 194 with a question box 196 and a plurality of answers 198. As will be further described below, local computer 12 may have an ad code 200 that is provided to a central computer which also has a central computer ad code 202. As will be further described below, the local computer ad code 200 is compared with the central computer ad code 202 to determine if current image links 194 are being displayed on display 26. Ad code 202 may, for example, be a digital word having a number of bits corresponding to a number of ads. To provide more efficient downloading of ads, only those ads with different bits will be downloaded.

Referring now to FIG. 9, upon answering a question posed in question box 196 of FIG. 8 a window 204 may be provided with the proper answer in a narrative box 206 as well as ad image 194 from FIG. 8. A point total box 208 may also be included such that if a proper answer was selected the point total 208 is increased. To encourage learning, the point totals may be redeemed for prizes including new image figures, games or other “fun” items desired by children. It is preferred that the point totals are redeemed for downloadable content to be included within the browser.

Narrative window 206 may provide the proper answer as well as a description and further links to encourage learning on the subject.

Of course, various numbers of points may be obtained during various days. In a preferred embodiment one point for each subject may be obtained each day and accumulated until spent on a prize.

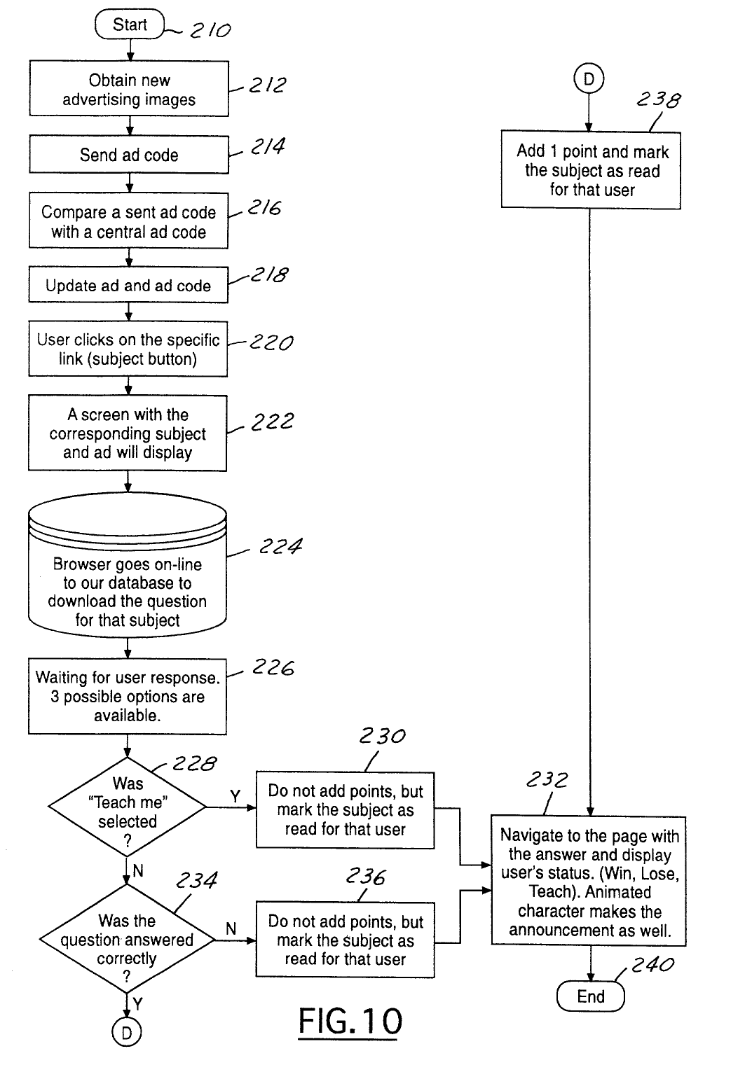

Referring now to FIG. 10, the sponsorship/advertising method is illustrated. The method is started in block 210. When this portion of the browser is invoked the advertising images or sponsorship images are obtained in step 212. After steps 212 an ad code is sent and compared to ad code in 216. As illustrated in FIG. 8, local computer may have a local computer ad code 200 while central computer may have a central computer ad code 202. Either the central computer ad code 202 may send its ad code to local computer for comparison step 216 or local computer may send its current ad code 200 to central computer 16. Preferably, local computer 12 obtains central computer ad code 202 and compares the ad code therein. As described above, each ad code preferably has bits corresponding to each of the ads that together form a digital word. If the ad code word 202 is different than the current local computer ad code 200, the local computer 12 requests central computer 16 to update ad code 200 and the ads therein in step 218. The browser has specific subject buttons 190 as described in FIG. 7. In step 220 the user clicks on the specific subject button and a screen with the corresponding subject ad will be displayed in a window 26 as is best shown in FIG. 8. The ad display and window is performed in step 222. In this embodiment, a question is obtained from central computer 16 and provided on the display of the computer in step 224. In step 226 the user is prompted for a response. Preferably, new questions are generated every 24 hours so that points may be obtained every day for each subject. In step 224, question, the answer, and the narrative article of the subject may all be downloaded at the same time from the central computer 16. A “teach me” button 199 may also be provided on window 192. If instead of answering the “teach me” button is provided, no points are added but the subject is marked as “read” for that user so that it points cannot be added for that day. The process continues in step 232 where the narrative and answer page is displayed. Preferably, an animated character makes an announcement for visual appeal. A submit button 203 may be used to send the selected button 198, 199.

Referring back to step 228, if “teach me” was not selected, the correct answer is compared to the given answer in step 234. If the correct answer was not given, points are not added but the subject is marked as read in step 236 and the process continues in step 232. If the question was answered correctly in step 234, a point is added and the subject is marked as read in step 238. After a point is added and the subject is marked as read, step 232 is executed in which the answer is displayed and a point total may also be displayed. The process ends at end block 240.

Variations of the above would be evident to those skilled in the art. For example, a character figure may congratulate each user when a point is added to the website. The unique characters may be one of the “prizes” that are available for download if enough points are obtained. Also, the questions may be generated by professional educators to ensure accuracy and that the proper content is provided to the proper grade level.

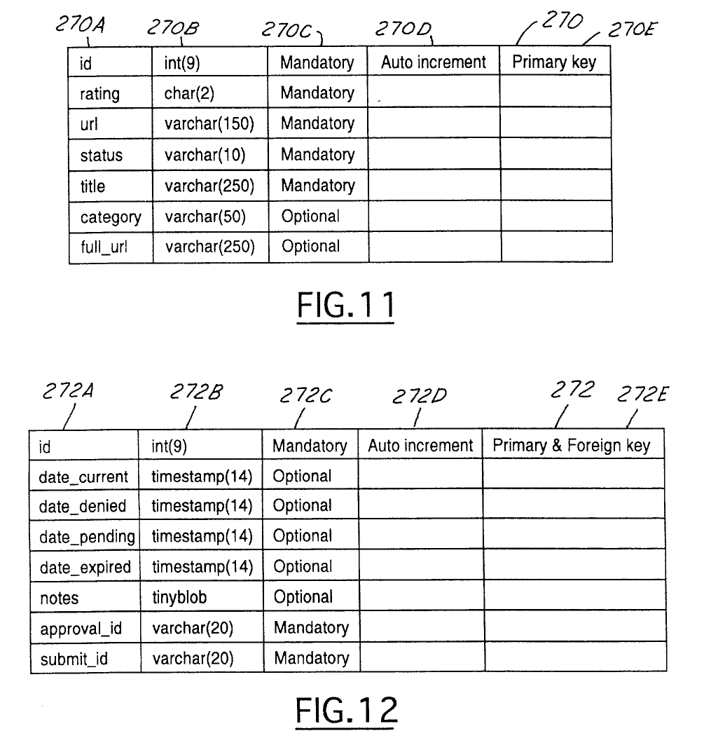

Referring now to FIG. 11, central controller 16 has a central database 30 as shown best in FIG. 1. Central database 30 may contain various information about each approved website. FIG. 11 illustrates a first table or domain name information 270 that stores information directly related to a domain name. The following variables are preferred variables for one example of the present invention. Those skilled in the art will recognize that various variables and various variable sizes may be used without deviating from the scope of the invention. The variables are in column 270A, column 270B. The number of characters for the field is in column 270B. Column 270C indicates whether the field is optional or mandatory. Columns 270D and 270E indicate information regarding automatically incrementing the field and the primary key of the field, respectively. ID is a nine-digit unique identifier for each record stored within table 270. Rating can have a value from 01 through 12 and may, for example, represent the security level wherein security level 0l is the most secure appeal. Of course, those skilled in the art will recognize that various numbers of security levels may be provided. URL represents the parsed domain name determined in the parsing steps of FIG. 4. The status field is important because it determines whether the domain name is approved, denied or pending. Another state of status could be “expired” which is used to signal maintenance that this site needs to be relocated. The title field stores the title for the domain name for easy identification. The category field is used to store codes that will be referenced for specific categories of domain names. As illustrated, the category field is an optional field in the current example. Full_URL represents the entire URL address for the particular domain name. This field is also optional.

Referring now to FIG. 12, statistical table 272 may include various information relating to statistical information about each link stored in the central database. The ID field is a foreign key for table 270 in FIG. 11 and serves as a primary key for table 272. Column 272A stores the variable name. The number of characters for the field is in column 272B. Column 272C indicates whether the field is optional or mandatory. Columns 272D and 272E indicate information regarding automatically incrementing the field and the primary key of the field, respectively. Date_current field is a time stamp of the date and the domain has been approved. The date_denied field is a time stamp when the domain has been denied. Date_pending field is a time stamp when the link has been set to pending. This field may represent a time stamp when a browser has requested the link for approval. Date_expired field is a time stamp when the link is no longer active. This may indicate that the website has moved.

The note field serves the purpose of documenting denial or other extra information about the domain. Approval_ID field records the person who has changed the status of the domain. Without an active approval ID one cannot change the status or other information about the domain. This provides a high level of security protection. This is valuable if an employee of the company leaves he or she will no longer be able to access the browser database. A submit_ID field is also provided to serve the purpose of tracking the browser identification of a submitting requester. Statistical data may be recorded in the time stamp field to track performance of the approval process. In the approval screening system 34 of FIG. 1, each and every piece of data about each domain name may be changed or updated. Each application has a unique key that is required in order to modify data. The key must be active in the database. Employees of the company will query the database to determine whether or not browsers have requested approval of new databases. This content can be easily retrieved using the databases of FIGS. 11 and 12. Security is also very high in such an application because both an active browser ID and an approval ID must be required before modifications can be made. If a hacker, for example, were to try to access the database, the server would not respond without both keys. A browser key may, for example, be hard coded into each browser to prevent tampering.

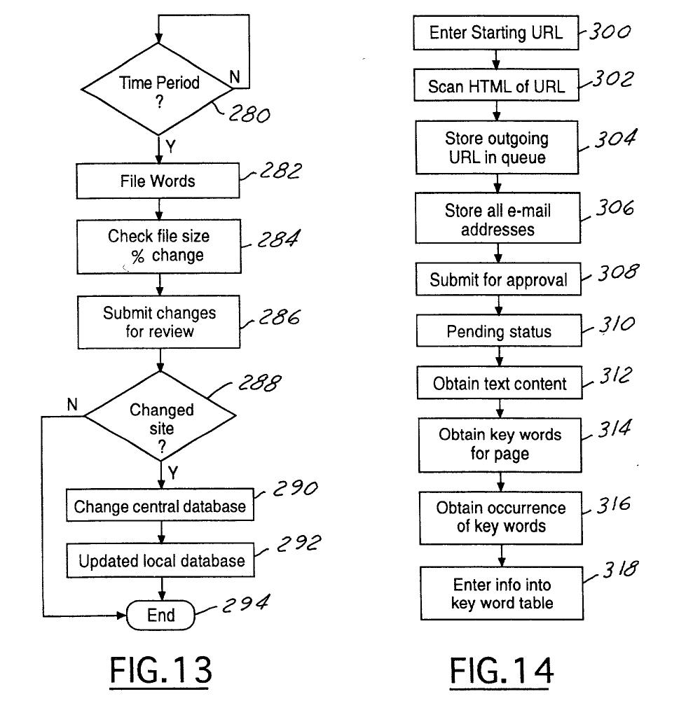

Referring now to FIG. 13, because Internet information changes nearly constantly, the system of the present invention allows approved websites to be monitored and their status changed. To provide monitoring, every predetermined time period the system may be checked. For example, the predetermined time period may be 24 hours. The time period is checked in step 280. If the time period has expired, a check of the database and the URLs or domain names therein is determined. To determine whether or not a website has changed, file words are checked in step 282 and file size percentage change is checked in step 284. If a significant amount of words of the website associated with the domain name have changed and the file size percentage has changed the website is submitted for review in step 286. Also, if inappropriate words have been added to the website, a review may be triggered in step 286. Step 286 will determine whether or not a website has changed its content enough to warrant a change in the database. In step 288, if it is determined that the website has changed and inappropriate content is acquired, step 290 is performed wherein the central database is changed. After step 290 the local databases must also be updated. The local databases are updated when the user logs in to the central database. A change will remove the website from the approved list of the local database upon log in.

Referring back to step 288, if the website has not changed the system ends in step 294. Likewise, after the local databases have been updated step 294 is also performed.

Referring now to FIG. 14, the central database may be formed by users requesting websites to be approved as well as building a website through a web spider. The web spider of the present invention requires a starting URL to be entered in step 300. The entire HTML document of the URL entered in step 302 is scanned. The outgoing URLs are stored in the queue of step 304. All e-mail addresses are also stored in a file in step 306. When a webpage has been analyzed by the spider, it is submitted for manual approval in step 308 and given a pending status in step 310. The HTML document is then analyzed and the text content is obtained in step 312. To obtain the text content various key words are obtained in step 314. Key words may be obtained in various manners depending on the website. For example, the first 250 characters of the website may be taken and stored as a description unless one is provided in HTML metatags. If the metatags contain keywords, the keywords are taken as well and the title of the website is also taken from the web browser object. If a keyword section does not exist in metatags, the HTML document may be scanned to find the occurrence of every single word in the page. The top 20 words may be then considered the key words of the page. The occurrence of any key word may be obtained in step 316. The key words and occurrences are entered into a key word table in step 318.

While the process in FIG. 14 has been described with respect to the web spider, the above mentioned process may also be used for approving submitted websites as well. Each link in the database may have a status such as pending, denied or expired. Links that are waiting for staff approval may have a pending rating. Also, the staff preferably reviews the information provided by the web spider to determine its accuracy. Also, the above process may also be used for a search engine database. Thus, only approved sites will be returned from a search engine search on such a browser.

While particular embodiments of the invention have been shown and described, numerous variations and alternate embodiments will occur to those skilled in the art. Accordingly, it is intended that the invention be limited only in terms of the appended claims.

What is claimed is:

1. A browser system for controlling access to a website comprising:
a network;
a user computer coupled to the network, said user computer having a local database with local database entries therein and a display;
a central database having central database entries coupled to the network;
a browser displayed on said display within said user computer having a domain name entry area for entering a domain name corresponding to the website; and
said user computer comprising a controller comparing the domain name to a plurality of local database entries within a local database, and when the domain name is not in the local database, said controller comparing the domain name to a plurality of central database entries in a central database, when the domain name is in the local database or central database, said controller enabling access to the website.

2. A browser system as recited in claim 1 further comprising an approval screening system coupled to said central database.

3. A browser system as recited in claim 1 wherein said network comprises the Internet.

4. A browser system as recited in claim 1 wherein said user computer further comprises a memory for storing a user security status, said local database and said central database storing a respective local database security status and a central database security status, said controller comparing said local database security status and said central database security status with said user security status, said controller enabling access to the website when said user security status corresponds to said local database security status or said central database security status.

5. A browser system as recited in claim 1 wherein said browser comprises a plurality of hot buttons, wherein at least one of said hot buttons comprises a subject button.

6. A method of accessing a web page comprising:
entering a domain name corresponding to a website;
comparing the domain name to a plurality of local database entries within a local database;
when the domain name is not in the local database, comparing the domain name to a plurality of central database entries in a central database; and
when the domain name is in the local database or central database, enabling access to the website.

7. A method as recited in claim 6 further comprising when the domain name is in a central database, storing the domain name in the local database.

8. A method as recited in claim 6 further comprising parsing the domain name prior to comparing the domain name to a plurality of local database entries.

9. A method as recited in claim 8 wherein the step of parsing comprises:
entering a full domain name having a plurality of character positions;
capturing the full domain name;
capturing a first domain name by capturing characters right of a “:” symbol and left of a “/” symbol to obtain a first name.

10. A method as recited in claim 6 wherein prior to comparing the domain name to a central database, determining if a network connection exists.

11. A method as recited in claim 6 wherein enabling comprises receiving the web page.

12. A method as recited in claim 6 wherein prior to the step of comparing, determining a user security level, wherein steps of comparing are performed as a function of user security level.

13. A method as recited in claim 6 further comprising when the domain name is not in the local database or central database, disabling access to the website.

14. A method as recited in claim 6 further comprising reviewing websites for predetermined content, adding reviewed domain name to the central database when predetermined content is found.

15. A method as recited in claim 13 wherein the step of reviewing comprises issuing a request for review in response to the step of disabling.

16. A method as recited in claim 13 wherein the step of adding comprises categorizing the predetermined content into age-appropriate categories.

17. A method as recited in claim 6 comprising the steps of reviewing a website for predetermined content, removing the website from the local database when predetermined content is found.

18. A method as recited in claim 6 wherein prior to the step of entering a domain name, checking a central controller for an updated version.

19. A method as recited in claim 6 further comprising the step of downloading said updated version when an updated version is available.

20. A method as recited in claim 6 further comprising the step of downloading updated advertising; and displaying said updated advertising on a display.

21. A method as recited in claim 6 wherein the step of entering comprises opening a hidden browser and obtaining the domain name from the hidden browser.

22. A method as recited in claim 6 further comprising determining a website size and comparing the website size to a size database entry to determine a change amount, when said reviewing and website change amount is greater than a predetermined amount.

23. A method as recited in claim 22 after the step of reviewing, changing a local database entry or a central database entry.

24. A method of sponsoring a website comprises:
generating a screen display having a plurality of subject buttons;
selecting and actuating a first subject button from said plurality of subject buttons;
displaying a question and a plurality of answers in response to the step of selecting;
displaying a first sponsor code on said display;
selecting a first answer from the plurality of answers;
display a narrative display in response to the step of selecting a first answer

25. A method as recited in claim 24 further comprising the steps of displaying a second sponsor code in response to the step of displaying a narrative display.

26. A method as recited in claim 24 further comprising the step of incrementing a point total in response to the step of selecting a first answer.

27. A method of sponsoring a website comprising:
providing a local computer ad code having a first plurality of bits and a central computer ad code and a second plurality of bits;
comparing the local computer ad code with the central computer ad code;
when the local computer ad code is not equal to the central computer ad code, downloading an ad to the local computer from the central computer.

28. A method as recited in claim 27 wherein the step of comparing comprises the step of comparing the first plurality of bits and the second plurality of bits.

30. A method as recited in claim 27 wherein said step of downloading comprises the step of downloading an ad to the local computer in response to the step of comparing the first plurality of bits.

31. A method as recited in claim 27 wherein the step of comparing the first plurality of bits comprises comparing each bit of said first plurality of bits to each bit of said second plurality of bits to obtain a respective plurality of comparisons in response thereto, and downloading an ad where comparison is not equal.

32. A method of selecting a website domain name comprising:
entering a full domain name having a plurality of character positions;
capturing the full domain name;
capturing a first domain name by capturing characters right of a first symbol and left of a second symbol to obtain a first name.

33. A method as recited in claim 31 wherein the step of capturing comprises the step of opening a hidden browser to obtain the full domain name.

34. A method as recited in claim 31 wherein the step of capturing comprises the step of opening a hidden browser to obtain the full domain name.

35. A method as recited in claim 31 wherein said first symbol is a “:” symbol.

36. A method as recited in claim 31 wherein said second symbol is a “/” symbol.

37. A method of selecting a website domain name comprising:
entering a full domain name having a plurality of character positions;
capturing the full domain name;
capturing a first domain name by capturing characters right of a “:” symbol and left of a “/” symbol to obtain a first name.
